(19) United States
(12) Patent Application Publication
(10) Pub. No.: US 2011/0314763 A1
(43) Pub. Date: Dec. 29, 2011

(54) ANCHORING EQUIPMENT, IN PARTICULAR FOR ROOF

(75) Inventor: Alberto Gandellini, Cohceoio (Brescia) (IT)

(73) Assignee: SI.AL. S.R.L., 25030 BRANDICO (BRESCIA) (IT)

(21) Appl. No.: 12/664,300

(22) PCT Filed: Dec. 18, 2007
(86) PCT No.: PCT/IB2007/055197

§ 371 Date: Jun. 30, 2011

(30) Foreign Application Priority Data
Dec. 27, 2006 (IT) BS2006A000230

(51) Int. Cl. E04D 13/12; E04G 21/32; A62B 1/04

(52) U.S. Cl. 52/698

(57) ABSTRACT

The present invention relates to an anchoring equipment (1), in particular for roofs (6), comprising two identical supporting elements (2, 3) having each an engagement portion (4, 5) that can be adapted to the shape of the roof (6) on which the equipment (1) has to be installed, and a fastening portion (7, 8) apt to be engaged by an end (20a, 20b) of a connecting rope (20) placed between said supporting elements. The equipment further comprises at least one retaining element (23) placed between the supporting elements (2, 3), provided with an engagement portion (24) that is identical to the engagement portion (4, 5) of each supporting element (2, 3). The retaining element (23) has a retaining portion (25) apt to retain possible transversal shifts of the connecting rope and to enable the sliding along the latter of at least one hooking and/or safety fixture used during maintenance operations carried out on the roof (6).

The present invention relates to an anchoring equipment, in particular for roofs.

The present invention concerns the field of safety systems for buildings industry.

In particular, the present invention relates to an anchoring equipment that is designed to be fastened onto roofs of any building and to which a connection can be established with suitable hooking fixtures so as to work on said roofs under totally safe conditions.

As is known, anchoring devices generally comprise two supporting elements or stakes designed to be fastened, spaced from each other, along a ridge of a corresponding roof of a building, such as for instance a house, a block of flats, a warehouse or the like.

As a rule, a hooking rope, suitably tightened, is arranged between the supporting stakes, to which rope a connection can be established by means of suitable slings or spring catches or similar safety fixtures.

In order to enable the engagement of the supporting stakes onto the corresponding roofs, each supporting stake is equipped with a base plate shaped according to the shape of the roof area in which it will be installed. In other words, the base plate of each supporting stake is carried out so as to reproduce the ridge shape of the recipient roof.

The base plate of each supporting stake further has a plurality of fastening holes for the engagement into corresponding fastening elements suitably selected depending on the type of connection to be achieved.

Although known anchoring devices enable a satisfactory hooking of suitable safety equipment, the Applicant has found that they are not deprived of some drawbacks and that they can be improved under various aspects, mainly concerning their flexibility of use, i.e. their adaptability to any roof or roof area in which they have to be installed, their overall size during transport and/or storage, as well as related costs.

In particular, it has been found that the supporting stakes of known devices are equipped with fastening plates suitably carried out depending on the outer shape of the roof area on which they have to be installed. Each supporting stake is coupled univocally to a fastening plate that can be used only on the roof area in which it has to be installed. As a result, each supporting plate is bound to a specific shape of the base plate and cannot be installed on a roof area having a different shape with respect to the one of the corresponding base plate.

Such structural arrangement significantly limits the use of known anchoring devices, which cannot be used on any roof since they are equipped with corresponding base plate that are specific only for the recipient roof.

Furthermore, it should be pointed out that the arrangement of fixed structures, such as base plates of supporting stakes, requires the assessment of the shape of the installation area before said plates are carried out, thus increasing the time lapse between the request of installation of the above mentioned equipment and the effective installation thereof, as well as costs related to such operations.

Eventually, it should be pointed out that due to the excessive overall width of each base plate with respect to the global volume of the corresponding supporting stake, known anchoring devices require an adequate space in terms of storage and of transport. Under these circumstances, the technical task underlying the present invention consists in providing an anchoring equipment, in particular for roofs, that can substantially obviate the drawbacks mentioned above.

An important aim of the invention within such technical task consists in conceiving a universal anchoring equipment, that is versatile and easily adaptable to any roof type.

Another technical task of the invention consists in providing an anchoring equipment with a small overall size.

A further technical task of the invention consists in providing a cost-effective anchoring equipment, as far as both structure and installation are concerned.

The technical task and the aims referred to above are basically achieved by an anchoring equipment, in particular for roofs, characterized in that it comprises one or more technical solutions claimed below.

The following contains the description of a preferred, though non-exclusive embodiment of an anchoring equipment, in particular for roofs, according to the invention, given by mere way of indicative, non-limiting example and shown in the accompanying drawings, wherein:

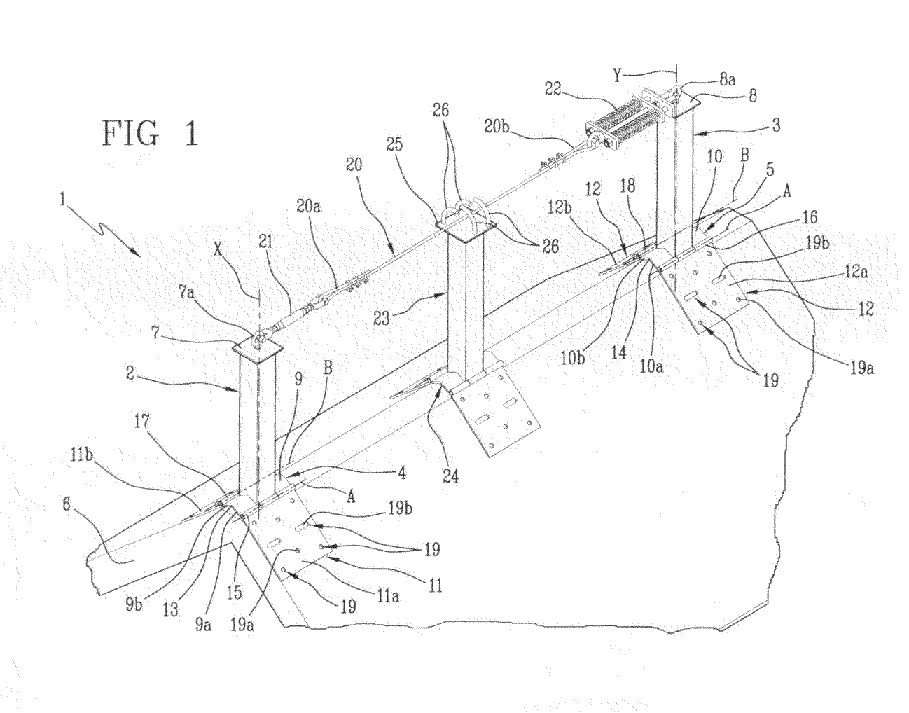

FIG. 1 is a perspective-view of an anchoring equipment, in particular for roofs, in accordance with the present invention and shown in a first installation position;

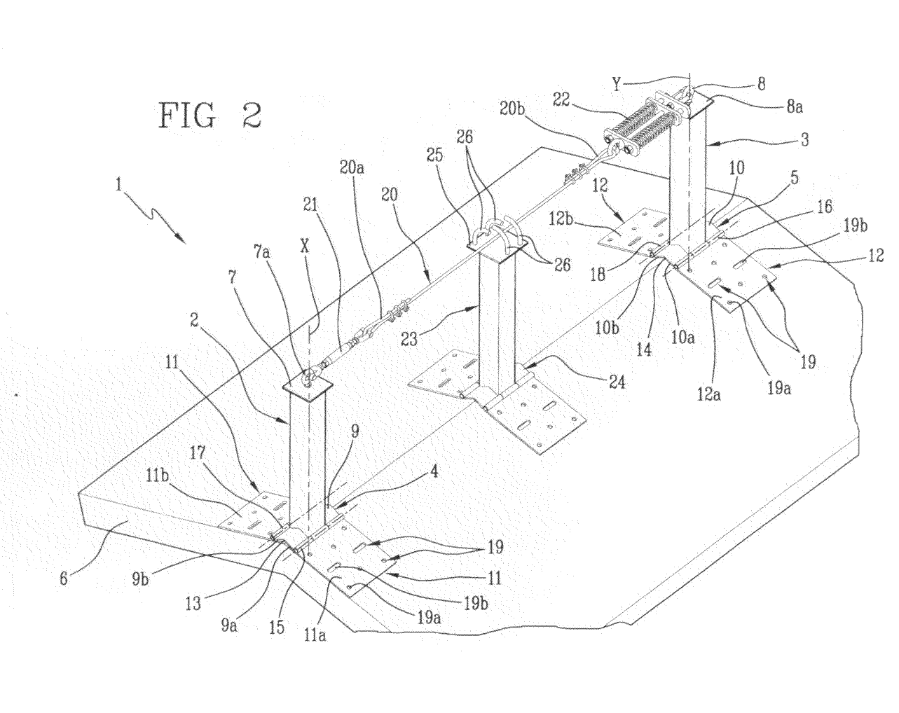

FIG. 2 is a perspective view of the equipment as in the preceding figure, shown in a second installation position;

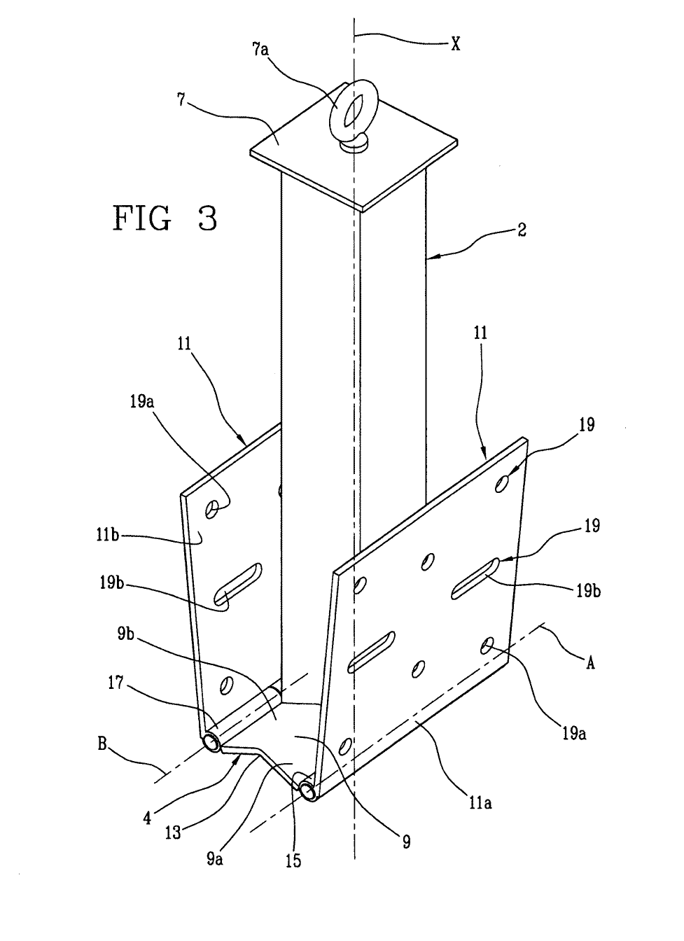

FIG. 3 is a perspective view of a supporting element of the equipment as in the preceding figures, shown in a suitable position for transport or storage thereof.

With reference to the accompanying figures, the numeral 1 globally refers to an anchoring equipment, in particular for roofs, in accordance with the present invention.

As shown in FIG. 1, the anchoring equipment 1 comprises at least one supporting element 2 and at least one auxiliary supporting element 3, which are basically identical and can be positioned at a pre-established distance from each other.

Each supporting element 2, 3 has preferably a basically prismatic body provided with an engagement portion 4, 5 that can be fastened onto a roof 6 (FIGS. 1 and 2), and a fastening portion 7, 8 opposed to the engagement portion 4,5, which can be engaged indirectly by a corresponding hooking element of an anchoring fixture (not shown).

Still with reference to the accompanying figures, the engagement portion 4, 5 of each supporting element 2, 3 comprises at least a fixed structure 9, 10 integral with the body of the corresponding supporting element 2, 3, and mobile engagement means 11, 12 operatively associated to the fixed structure 9, 10 so as to adapt the corresponding engagement portion 4,5 to the shape of the recipient roof 6.

In further detail, the fixed structure 9, 10 of each supporting element 2, 3 has a first inclined segment 9a, 10a extending obliquely with respect to a longitudinal axis of development “X”, “Y” of the corresponding supporting element 2, 3, and a second inclined segment 9b, 10b extending obliquely with respect to the longitudinal axis of development “X”, “Y” of the corresponding supporting element 2, 3.

Advantageously, the inclined segments 9a, 9b, 10a, 10b of each supporting element 2, 3 converge one to the other approaching the longitudinal axis of development “X”, “Y” of the corresponding supporting element 2, 3, thus defining a respective angle of engagement 13, 14 facing away from the corresponding fastening portion 7, 8.

The angle of engagement 13, 14 subtended by the inclined segments 9a, 9b, 10a, 10b of the engagement portion 4,5 of each supporting element 2, 3 has an angle as wide as or less wide than the corresponding angle of inclination of the roof top.

Each inclined segment 9a, 9b, 10a, 10b of the engagement portion 4, 5 has the maximum pitch allowable for roofs, preferably between a minimum value of 35% and a maximum value of 50%. Thus, when the pitch of the inclined segments 9a, 9b, 10a, 10b corresponds to the pitch of the roof 6, the fixed structure 9, 10 can possibly abut onto the latter on its ridge. Conversely, when the pitch of the roof 6 is smaller than the pitch of the above mentioned inclined segments 9a, 9b, 10a, 10b (FIG. 2), of the respective fixed structure 9, 10 of each supporting element 2, 3, the latter structure rests with lower edges onto the corresponding pitch of the roof 6.

As can be seen in the accompanying figures, the inclined segments 9a, 9b, 10a, 10b of the fixed structure 9, 10 of each supporting element 2, 3 have preferably a basically plate-like shape. Still with reference to the accompanying figures, the mobile engagement means 11, 12 comprise a first mobile structure 11a, 12a operatively engaged to the fixed structure 9, 10 so as to adapt the engagement portion 4, 5 of the supporting element 2, 3 to the shape of the roof 6.

Preferably, the first mobile structure 11a, 12a is operatively engaged to the first inclined segment 9a, 10a of the corresponding fixed structure 9, 10 on the side facing away from the corresponding angle of engagement 13, 14.

Advantageously, the first mobile structure 11a, 12a is turnably engaged to the first inclined segment 9a, 10a so as to rotate with respect to the latter around a first axis of rotation “A” transversal with respect to the corresponding axis of longitudinal development “X”, “Y” of the corresponding supporting element 2, 3. More to the point, the first mobile structure 11a, 12a is hinged to the first inclined segment 9a, 10a, preferably by way of a corresponding pin joint 15, 16.

Still with reference to the accompanying figures, the mobile engagement means 11, 12 further comprise a second mobile structure 11b, 12b operatively engaged to the respective fixed structure 9, on the side facing away from the first mobile structure 11a, 12a. In further detail, the second mobile structure 11b, 12b is operatively engaged to the second inclined segment 9b, 10b on the side facing away from the corresponding angle of engagement 13, 14.

Preferably, the second mobile structure 11b, 12b is turnably engaged to the second inclined segment 9b, 10b so as to rotate with respect to the latter around a second axis of rotation “B” transversal with respect to the corresponding axis of longitudinal development “X”, “Y” of the corresponding supporting element 2, 3, and basically parallel to the first axis of rotation “A”. More specifically, the second mobile structure 11b, 12b is hinged to the second inclined segment 9b, 10b, preferably by way of a corresponding pin joint 17, 18.

Like the inclined segments 9a, 9b, 10a, 10b of the fixed structures 9, 10, the mobile structures 11a, 11b, 12a, 12b of the mobile engagement means 11, 12 have each a basically plate-like shape.

Advantageously, each mobile structure 11a, 11b, 12a, 12b further has at least one through opening 19 for the engagement of a corresponding connecting element (not shown) apt to fasten the corresponding supporting element 2, 3 to the roof 6.

In accordance with the solution shown in the accompanying figures, each mobile structure 11a, 11b, 12a, 12b has a plurality of through openings 19 for the engagement of corresponding connection elements selected depending on the type of connection to be achieved and on the material which the structural portion of the roof 6 onto which the connection elements engage is made of.

Advantageously, at least one of the through openings 19 of each mobile structure 11a, 11b, 12a, 12b is made up of a circular hole 19a, whereas at least one is made up of a slot 19b having a basically oblong shape.

Still with reference to the accompanying figures, the fastening portion 7, 8 of each supporting element 2, 3 is provided with at least one hooking ring 7a, 8a for the direct and/or indirect engagement of at least one suitable hooking and/or safety fixture. Advantageously, the equipment 1 comprises at least one connecting rope 20, preferably made of steel, extending between the fastening portions 7, 8 of the corresponding supporting elements 2, 3. More specifically, the connecting rope 20 has a first end 20a hooked to the hooking ring 7a of the fastening portion 7 of the supporting element 2, and a second end 20b, opposed to the first end 20a and hooked to the hooking ring 8a of the fastening portion 8 of the auxiliary supporting element 3, thus providing the above mentioned hooking and/or safety fixture with a long hooking structure on which it can slide between the supporting elements 2, 3.

With reference to FIGS. 1 and 2, the first end 20a of the connecting rope 20 is hooked to the fastening portion 7 of the supporting element 2 by way of at least one tensioning member 21 of known type, which will therefore not be described in further detail in the present description. The second end 20b of the connecting rope 20 is preferably hooked to the fastening portion 8 of the auxiliary supporting element 3 by way of at least one damping member 22, which is again of known type and will therefore not be described in further detail.

Advantageously, the equipment 1 further comprises at least one intermediate retaining element 23, placed between the supporting elements 2, 3 so as to impede possible transversal shifts of the connecting rope 20 within pre-established limits.

A plurality of identical retaining elements 23, suitably spaced away depending on the length of the connecting rope 20 and on the distance between the supporting elements 2, 3, can also be arranged between the supporting elements 2, 3.

As can be seen in FIGS. 1 and 2, the intermediate retaining element 23 has an engagement portion 24, which can be fastened onto the roof 6 on the ridge thereof and which is preferably identical the engagement portion 4, 5 of the supporting elements 2, 3. On the side facing away from the engagement portion 24, the retaining element has a retaining portion 25 surrounding transversally the connecting rope, at least partially.

In further detail, the retaining portion 25 is provided with at least two basically curved extensions 26, extending each partially around the cross section of the connecting rope 20. Preferably, the curved extensions 26 extend symmetrically one to the other with respect to the longitudinal axis of the connecting rope 20 and are advantageously offset along the longitudinal development of said connecting rope 20 so as to enable the passage of the spring catch or similar hooking element of the hooking and/or safety fixture.

In accordance with the solution shown in FIGS. 1 and 2, the retaining portion 25 is provided with four identical retaining extensions 26, arranged in offset potions along the longitudinal development of the connecting rope so as to define a retaining cage 27 apt to retain the transversal shifts of said rope. Stated otherwise, the curved extensions 26 define a structure surrounding transversally the connection rope completely, so that the latter is confined within a pre-established narrow space.

The invention solves the problems of the prior art and achieves important advantages.

First of all, the anchoring equipment 1 is versatile and of simple installation. In particular, the anchoring equipment according to the present invention can be easily installed onto any roof or similar cover, whatever the shape of the recipient roof or roof area. As a matter of fact, the arrangement of supporting elements 2, 3 whose engagement portions 4, 5 have corresponding mobile structures 11a, 11b, 12a, 12b, which can vary the shape of the corresponding engagement portions 4, 5 depending on the shape of the roof 6, enables to obtain basically identical supporting elements 2, 3 and/or retaining elements 23, thus avoiding dedicated engagements plates suiting the particular shape of the recipient areas. Moreover, the structural configuration of the above mentioned supporting elements 2, 3 and/or retaining elements 23 enables to install the equipment onto roofs developing on one plane (either horizontal or inclined); having the same pitch on all sides; or having different pitches, i.e. in which the inclination of one of the two slopes is higher than the other.

It should further be pointed out that the particular structure of the engagement portions 4, 5, 24 of the supporting elements 2, 3 and of the retaining element 23 enables a significant reduction of the overall size of the equipment 1 during transport and storage, as shown in FIG. 3.

Finally, it should be pointed out that the present invention further enables a high reduction of costs related to the design, construction and installation of the above-mentioned devices 1, thanks to the elimination of the preliminary step involving the assessment of the shape of the recipient roof area; the engagement portions 4, 5, 24 can be mass-manufactured thanks to their identical shape; and the adaptability of the engagement portions 4, 5, 24 to different roof shapes simplifies and accelerates the installation of the equipment 1.

1-28. (canceled)

29. Anchoring equipment (1), in particular for roofs (6), comprising at least one supporting element (2) having an engagement portion (4) that can be fastened onto at least one roof (6), and a fastening portion (7), opposed to said engagement portion (4), which can be engaged by a corresponding hooking element of a pre-determined anchoring fixture,
wherein said engagement portion (4) of said supporting element (2) comprises:
at least one fixed structure (9) integral with said supporting element (2); and
mobile engagement means (11) operatively associated to said fixed structure (9) so as to adapt said engagement portion (4) of said supporting element (2) to the shape of said roof (6),
wherein said fixed structure (9) comprises:
a first inclined segment (9a) extending obliquely with respect to an axis of longitudinal development (“X”) of said supporting element (2);
a second inclined segment (9b) extending obliquely with respect to an axis of longitudinal development (“X”) of said supporting element (2), said inclined segments (9a, 9b) converging one to other approaching said axis of longitudinal development (“X”) of said supporting element (2) so as to define an angle of engagement (13) facing away from the fastening portion (7) of said supporting element (2), wherein said mobile engagement means (11) comprise a first mobile structure (11a) operatively engaged to said fixed structure (9) so as to adapt said engagement portion (4) of said supporting element (2) to the shape of said roof (6), wherein said first mobile structure (11a) is operatively engaged to said first inclined segment (9a) on the side facing away from said angle of engagement (13), and wherein said first mobile structure (11a) is turnably engaged to said first inclined segment (9a), said first mobile structure (11a) and first inclined segment (9a) being relatively turnable around a first axis of rotation (“A”) transversal with respect to the axis of longitudinal development (“X”) of said supporting element (2).

30. The equipment according to claim 29, wherein said first mobile structure (11a) is hinged to said first inclined segment (9a).

31. The equipment according to claim 30, wherein said first mobile structure (11a) is hinged to said first inclined segment (9a) by way of at least one pin hinge (15).

32. The equipment according to claim 29, wherein said mobile engagement means (11) further comprise a second mobile structure (11b) operatively engaged to said fixed structure (9) on the side facing away from said first mobile structure (11a), so as to adapt said engagement portion (4) of said supporting element (2) to the shape of said roof (6), wherein said second mobile structure (11b) is operatively engaged to said second inclined segment (9b) on the side facing away from said angle of engagement (13), and wherein said second mobile structure (11b) is turnably engaged to said second inclined segment (9b), said second mobile structure (11b) and second inclined segment (9b) being relatively turnable around a second axis of rotation (“B”) transversal with respect to the axis of longitudinal development (“X”) of said supporting element (2).

33. The equipment according to claim 32, wherein said second mobile structure (11b) is hinged to said second inclined segment (9b).

34. The equipment according to claim 33, wherein said second mobile structure (11b) is hinged to said second inclined segment (9b) by way of a pin hinge (17).

35. The equipment according to claim 29, wherein said angle of engagement (13) subtended by said inclined segments (9a, 9b) of said engagement portion (4) is as wide as or less wide than the corresponding angle of inclination of the roof top.

36. The equipment according to claim 29, wherein said inclined segments (9a, 9b) have each a basically plate-like shape.

37. The equipment according to claim 32, wherein said mobile structures (11a, 11b) have each a basically plate-like shape.

38. The equipment according to claim 37, wherein each mobile structure (11a, 11b) has at least one through opening (19) for the engagement of a corresponding connection element for said roof (6), wherein each mobile structure (11a, 11b) has a plurality of through openings (19) for the engagement of corresponding connection elements for said roof (6), wherein at least one of said through openings (9) of each mobile structure (11a, 11b) is a circular hole (19a) and at least one of said through openings (19) is a slot (19b) having a basically oblong shape.

39. The equipment according to claim 29, wherein said supporting element (2) has a substantially prismatic body provided with said engagement portion (4) and with said fastening portion (7) opposed to the engagement portion (4), and wherein said fixed structure (9) is unmovably integral with said body.

40. The equipment according to claim 29, wherein said fastening portion (7) of said supporting element (2) is provided with at least one hooking ring (7a) for the direct and/or indirect engagement of said hooking fixture.

41. The equipment according to claim 29, wherein it further comprises at least an auxiliary supporting element (3) identical to said supporting element (2), said supporting elements (2, 3) being connected to one another by at least one connecting rope (20) extending between the respective fastening portions (7, 8) of said supporting elements (2, 3), wherein said connecting rope (20) is hooked to said fastening portion (7) of said supporting element (2) by way of at least one tensioning member (21) and is hooked to the fastening portion (8) of said auxiliary supporting element (3) by way of at least one damping member (22).

42. The equipment according to claim 41, further comprising at least one intermediate retaining element (23) placed between said supporting elements (2, 3) so as to contrast transversal shifts of said connecting rope (20) within pre-established limits, wherein said intermediate retaining element (23) has an engagement portion (24) that can be fastened onto said roof (6) and is identical to the engagement portion (4, 5) of said supporting elements (2, 3), and a retaining portion (25) opposed to said engagement portion (24) and surrounding transversally said connecting rope (20), at least partially.

43. The equipment according to claim 42, wherein said retaining portion (25) of said retaining element (23) is provided with at least two basically curved extensions (26), each extending partially around the cross section of said connecting rope (20), said curved extensions (26) being offset along the longitudinal development of said connecting rope (20) and developing specularly to one another with respect to the longitudinal axis of said connecting rope (20).

44. The equipment according to claim 30, wherein said second mobile structure (11b) is hinged to said second inclined segment (9b), wherein said inclined segments (9a, 9b) have each a basically plate-like shape, wherein said mobile structures (11a, 11b) have each a basically plate-like shape, and wherein, when the pitch of the inclined segments (9a, 9b) corresponds to the pitch of the roof, each of said inclined segments (9a, 9b) is coplanar with the respective mobile structure (11a, 11b).

45. The equipment according to claim 44, wherein, when the pitch of the inclined segments (9a, 9b) corresponds to the pitch of the roof, said hinge (15) lies completely above said plane coplanar with each of said inclined segment and with said respective mobile structure.

46. The equipment according to claim 29, wherein each inclined segment (9a, 9b) of the engagement portion (4) has the maximum pitch allowable for roofs, between a minimum value of 35% and a maximum value of 50%.

47. The equipment according to claim 29, wherein, when the pitch of the inclined segments (9a, 9b) corresponds to the pitch of the roof, the fixed structure (9) rests completely onto the roof in correspondence to the ridge thereof.

48. The equipment according to claim 29, wherein said first mobile structure (11a) is hinged to said first inclined segment (9a) by way of one pin hinge (15) and said second mobile structure (11b) is hinged to said second inclined segment (9b) by way of a respective pin hinge (17), each pin hinge (15; 17) comprising two external hollow cylinders integral with the respective mobile structure (11a; 11b) and a central hollow cylinder integral with the respective inclined segment (9a; 9b), the central hollow cylinder being interposed between the two external hollow cylinders and axially aligned thereto so that the pin passes through all three hollow cylinders axially thereto.
